(19) United States
(12) Patent Application Publication
(10) Pub. No.: US 2006/0244805 A1
(43) Pub. Date: Nov. 2, 2006

(54) Multicolor pen

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/115,284

(22) Filed: Apr. 27, 2005

(51) Int. Cl. B41J 3/36

(52) U.S. Cl. 347/109

(57) ABSTRACT

A multicolor pen comprises an attachable and detachable pen body. A plurality of control buttons and a screen are mounted on the periphery of the pen body. A refill, which is connected to a pen nib, is mounted at the front end of the pen body. A control circuit, a battery, and four independently mounted yellow, magenta, cyanine blue, and black ink cartridges are mounted on the inside of the pen body. The control buttons and the screen are electrically connected with the control circuit. The ink cartridges are connected with the refill via a flow control valve. By operation of the control buttons and confirming operation of the screen, the control circuit controls the flow control valve to mix up the inks stored in the four-color ink cartridges for forming various colors besides these four colors. Accordingly, the multicolor pen is provided with diversified and lively writing effect.

### FIELD OF THE INVENTION

The present invention relates to a multicolor pen capable of changing color at will for providing diversified and lively writing effect, and more particularly to a structure suitable for ball-point pens, fountain pens, color pens, etc.

### BACKGROUND OF THE INVENTION

Pen is a kind of very convenient tool. The commonly used ball-point pen includes the monochromatic pen such as black, blue, or red pen, which will not be weeded out, and further includes the bicolor pen, the tri-color pen, and the multicolor pen.

Taiwan Patent Publication No. 580,991, entitled “IMPROVED COLOR PEN”, discloses this kind of structure comprising a transparent hollow pen shaft having a front end and a rear end; a shrinkable clipping means comprising a refill tube mounted in the transparent hollow pen shaft for holding a refill and a containing chamber formed between the outside of the refill tube and the inner wall of the pen shaft for holding a plurality of refills; a clipping means connected to a spring, the clipping means being mounted at the end of the refill tube in a position corresponding to the front end of the pen shaft for clipping the refill and pushing the refill; and a pressing means mounted on the rear end of the refill tube, the pressing means functioning as a detachable means for enclosing the opening of the refill tube and providing the function of pressing the refill tube, wherein a cover is attached to the pressing means for holding the refill inside the pen shaft, thereby constituting the color pen having the replaceable refills.

Although the above-mentioned pen shaft is provided with several refills for the purpose of providing several colors for a single pen, the shown color of the written text is still confined to the predetermined ink colors of the refills. Accordingly, the absence of the capability of changing color at will is the principal drawback of the conventional structure.

In view of the drawback of the conventional structure, the present invention provides the consumer with a multicolor pen capable of changing color at will and provides the written text with diversified and lively effect in accordance with the motive of the present invention.

### SUMMARY OF THE INVENTION

It is a main object of the present invention to provide a multicolor pen with diversified and lively writing effect.

It is another object of the present invention to provide a multicolor pen capable of forming various colors without being confined to the amount of refill.

In order to achieve the aforementioned object, the multicolor pen of the present invention comprises an attachable and detachable pen body. A plurality of control buttons and a screen are mounted on the periphery of the pen body. A refill, which is connected to a pen nib, is mounted at the front end of the pen body. A control circuit, a battery, and four independently mounted yellow, magenta, cyanine blue, and black ink cartridges are mounted on the inside of the pen body. The control buttons and the screen are electrically connected with the control circuit. The ink cartridges are connected with the refill through a flow control valve. By operation of the control buttons and confirming operation of the screen, the control circuit controls the flow control valve to mix up the inks stored in the four-color ink cartridges for providing various colors besides these four colors. Accordingly, the multicolor pen is provided with diversified and lively writing effect.

The aforementioned aspects and advantages of the present invention will be readily clarified in the description of the preferred embodiments and the enclosed drawings of the present invention.

### BRIEF DESCRIPTION OF THE DRAWINGS

FIG. 1 is an elevational view of the preferred embodiment of the present invention.

FIG. 2 is a schematic view showing the inside of the preferred embodiment of the present invention.

FIG. 3 shows another preferred exemplified embodiment of the present invention.

### DETAILED DESCRIPTION OF THE PREFERRED EMBODIMENT

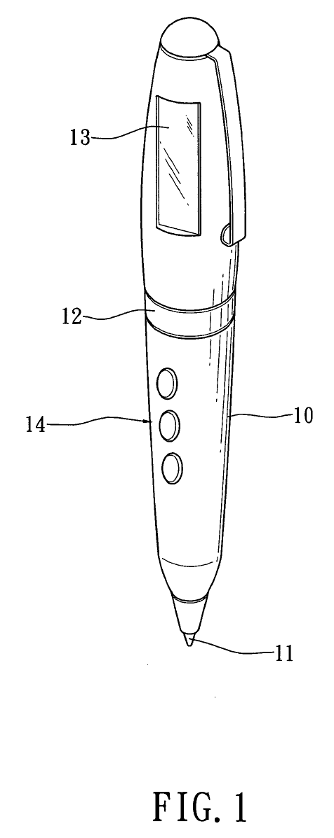

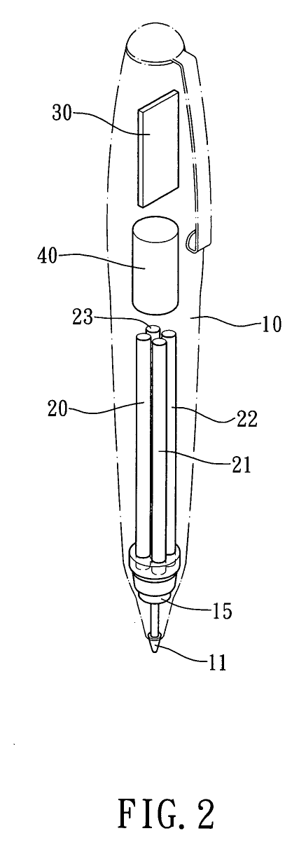

Referring to FIG. 1 and FIG. 2, the multicolor pen disclosed in the present invention comprises a connecting means 12 for being attached to and/or detached from the pen body 10. A refill, which is connected to a pen nib 11, is mounted at the front end of the pen body 10. In this preferred embodiment, the pen nib 11 is exemplified by a pen nib of a ball-point pen. Besides, a screen 13 and several control buttons 14 are mounted on the periphery of the pen body 10. A control circuit 30, a battery 40, and four independent black, yellow, magenta, and cyanine blue ink cartridges 20, 21, 22, and 23 are mounted on the inside of the pen body 10. Moreover, a flow control valve 15 is mounted at the rear end of the refill, wherein the control buttons 14, the screen 13, and the flow control valve 15 are electrically connected with the control circuit 30 to form an integral circuit.

When in use, the control buttons 14 are applied to appoint and confirm the required color, and the appointed color is shown on the screen 13 simultaneously. If the appointed color is a monochromatic color selected from yellow, magenta, cyanine blue, and black colors, the control circuit 30 will send a confirmation signal to the flow control valve 15 to permit the ink having the appointed color to flow into the refill via the flow control valve 15. Accordingly, the color outputted from the pen nib 11 is the appointed color.

If the appointed color is not one of the yellow, magenta, cyanine blue, and black colors, the control circuit 30 sends the confirmation signal to the flow control valve 15. Next, the flow control valve 15 controls the flow rates of the black ink cartridge 20, yellow ink cartridge 21, magenta ink cartridge 22, and cyanine blue ink cartridge 23 to mix up these four-color inks in a corresponding ratio according to the confirmation signal. Accordingly, the color outputted from the pen nib 11 is the appointed color, which is set by use of the control buttons 14.

Besides, the flow control valve 15 adopts a mechanical switch or an electronic switch. The mechanical switch is a micro switch. The electronic switch is a thermal bubble switch or a piezoelectric switch. In the thermal bubble switch, when the electric current flows through the resistor, the transient high heat results in the formation of the bubbles that produces pressure by which the mixing of the inks is speeded up. In the piezoelectric switch, the electric current vibrates the heating device by which the inks are mixed up more uniformly for outputting the appointed color.

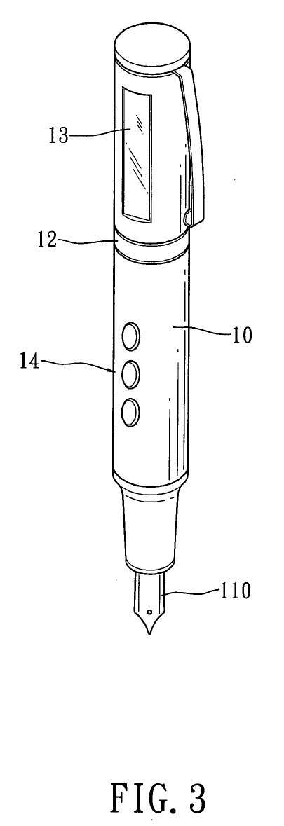

Nevertheless, when there is a need to appoint another color, the pen nib 11 may not be able to show this newly appointed color immediately. In order to apply the newly appointed color to the predetermined paper, book, or document, the pen nib 11 is first applied to a piece of waste paper to exhaust the remaining ink, which is appointed previously, from the refill until the newly appointed color is shown. Accordingly, the single multicolor pen is capable of forming all kinds of colors. Moreover, the structure disclosed in the present invention can be applied to all kinds of pens. The pen nib 11 of the present invention is not limited to the pen nib of the ball-point pen (shown in FIG. 1), and it can be exemplified by the pen nib of a fountain pen 110 (shown in FIG. 3), a roller pen, a marker pen, a color pen, etc. The components of the inks can be varied with the type of the pen. Furthermore, these four independent black, yellow, magenta, and cyanine blue ink cartridges 20, 21, 22, and 23 can be designed to be disposable ink cartridges or refillable ink cartridges.

The ink cartridges mounted inside the pen body 10 is not limited to the above-mentioned four-color ink cartridges 20, 21, 22, and 23. Alternatively, the pen of the present invention may include monochromatic, bicolor, or tri-color ink cartridge(s) because various colors can be obtained by mixing up two inks having different colors.

From the aforementioned description, the present invention provides the following advantages, in which:

1. The black, yellow, magenta, cyanine, and blue ink cartridges are independently mounted inside the pen body. Accordingly, all kinds of colors including these four colors can be obtained by mixing up these four-color inks.

2. By changing the type of the pen nib and the components of the inks, the present invention can be applied to various writing tools such as ball-point pens, fountain pens, drawing pens, color pens, marker pens, writing brushes, etc.

3. The present invention mixes up four-color inks to form all kinds of colors and provide the diversified and lively writing ability for overcoming the drawback of the conventional structure in which the pen is varied with the required color.

On the basis of the aforementioned description, it is apparent that the present invention can achieve the expected purposes. The present invention satisfies all requirements for a patent and is submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A multicolor pen, comprising:
an attachable and detachable pen body;
a plurality of control buttons and a screen mounted on the periphery of said pen body;
a refill mounted at the front end of said pen body;
a pen nib connected to said refill; and
a control circuit, a battery, and at least two independent different color ink cartridges mounted in said pen body, wherein said control buttons and said screen are electrically connected with said control circuit by which a flow control valve is controlled, and said ink cartridges are connected with said refill via said flow control valve such that said control circuit controls said flow control valve by operation of said control buttons and confirming operation of said screen so as to mix up inks stored in said ink cartridges in corresponding ratios for forming various colors and providing said multicolor pen with diversified and lively writing effect.

2. The multicolor pen of claim 1, wherein said at least two independent different color ink cartridges comprise four independent ink cartridges for respectively providing yellow, magenta, cyanine blue, and black inks for forming various colors by mixing up said inks in said corresponding ratios.

3. The multicolor pen of claim 1, wherein said flow control valve adopts a mechanical switch or an electronic switch.
